(19) United States
(12) Patent Application Publication
(10) Pub. No.: US 2026/0004491 A1
(43) Pub. Date: Jan. 1, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventors: Jie CHEN, Beijing (CN); Yulin ZHANG, Beijing (CN); Zhixuan WEI, Beijing (CN); Jie FAN, Beijing (CN); Jiantong OU, Beijing (CN); Wenhao LI, Beijing (CN); Hansi ZHAO, Beijing (CN); Yuening ZHANG, Beijing (CN); Aobiao CAI, Beijing (CN); Bo LIU, Beijing (CN); Shuai LI, Beijing (CN); Xinghua ZHANG, Beijing (CN)

(21) Appl. No.: 19/253,602

(22) Filed: Jun. 27, 2025

(30) Foreign Application Priority Data
Jun. 28, 2024 (CN) 202410865811.1

(51) Int. Cl. G06T 11/60; G06T 7/13; G06T 7/194; G06T 7/90

(52) U.S. Cl. CPC G06T 11/60; G06T 7/13; G06T 7/194; G06T 7/90

(57) ABSTRACT

Embodiments of the present disclosure relate to an image processing method and apparatus, a device, and a medium. The method includes: obtaining a first image and a second image, where the second image is an image obtained based on a material to be projected onto the first image; determining distortion information corresponding to pixels in the second image based on the first image, and generating a mixed image based on the first image, the second image, and the distortion information; obtaining target edge information of the mixed image; and generating a target image based on the mixed image and the target edge information. The embodiments of the present disclosure can achieve a realistic effect of projecting the material onto the first image, that is, can provide a user with a realistic projection effect, which is conductive to meeting a need of the user for effects.

### CROSS-REFERENCE TO RELATED APPLICATION(S)

This application claims priority to Chinese Application No. 202410865811.1 filed in Jun. 28, 2024, the disclosure of which is incorporated herein by reference in its entirety.

### FIELD

The present disclosure relates to the field of image processing technologies, and in particular, to an image processing method and apparatus, a device, and a medium.

### BACKGROUND

Nowadays, more and more ordinary users, professional editors, and other people need to use multimedia editing software to edit raw multimedia materials, such as images captured during filming. Most existing multimedia editing software can provide an effect processing function, such as adding an effect to an image uploaded by a user, thereby enhancing the emotional impact and fun of videos.

### SUMMARY

To solve the above technical problems or at least partially solve the above technical problems, the present disclosure provides an image processing method and apparatus, a device, and a storage medium.

An embodiment of the present disclosure provides an image processing method. The method includes: obtaining a first image and a second image; where the second image is an image obtained based on a material to be projected onto the first image; determining distortion information corresponding to pixels in the second image based on the first image, and generating a mixed image based on the first image, the second image, and the distortion information; obtaining target edge information of the mixed image; and generating a target image based on the mixed image and the target edge information.

Optionally, the method further includes: determining a target region to be processed in the first image based on layer information of the first image and layer information of the second image, where the layer information includes a layer size and a layer position; wherein determining the distortion information corresponding to pixels in the second image based on the first image includes: determining the distortion information corresponding to the pixels in the second image based on the target region in the first image; and wherein obtaining the target edge information of the mixed image includes: obtaining edge information of a target region in the mixed image to obtain the target edge information, where the target region in the mixed image corresponds to the target region in the first image.

Optionally, determining the distortion information corresponding to the pixels in the second image based on the target region in the first image includes: obtaining depth information of a first sub-region in the target region in the first image, and determining distortion information of the pixels, corresponding to a position of the first sub-region, in the second image based on the depth information, where the first sub-region is a region, having a specified object feature, in the target region; and obtaining color information of a second sub-region in the target region in the first image, and determining distortion information of the pixels, corresponding to a position of the second sub-region, in the second image based on the color information, where the second sub-region is a region in the target region other than the first sub-region.

Optionally, obtaining the edge information of the target region in the mixed image to obtain the target edge information includes: performing edge extraction on the target region in the mixed image to obtain an edge extraction result; and obtaining a foreground mask image of the first image, and generating a third image based on the foreground mask image and the edge extraction result, where a target region in the third image has a target edge texture, a foreground sub-region in the target region in the third image is a darkened region, a background sub-region in the target region in the third image is a brightened region, and the target region in the third image corresponds to the target region in the first image.

Optionally, generating the target image based on the mixed image and the target edge information includes: obtaining light color information corresponding to pixels in the target region in the mixed image based on the mixed image and the target edge information; and generating the target image based on the light color information and the mixed image.

Optionally, the target edge information is represented through the third image, and the target region in the third image has the target edge texture; and obtaining light color information corresponding to pixels in the target region in the mixed image based on the mixed image and the target edge information includes: performing Gaussian blurring on the target region in the third image to obtain a fourth image; generating, based on the mixed image and the fourth image, a fifth image carrying light intensities of the pixels; and obtaining the light color information corresponding to the pixels in the target region in the mixed image based on the fifth image.

Optionally, generating, based on the mixed image and the fourth image, the fifth image carrying the light intensities of the pixels includes: fusing the mixed image with the fourth image to obtain the fifth image; and determining the light intensities of pixels of a target region in the fifth image based on grayscale values of the pixels of the target region in the mixed image, and storing the light intensities of the pixels to a transparency channel of the fifth image.

Optionally, obtaining the light color information corresponding to the pixels in the target region in the mixed image based on the fifth image includes: performing Gaussian blurring on a target region in the fifth image to obtain a sixth image; and obtaining the light color information corresponding to the pixels in the target region in the mixed image based on the fifth image and the sixth image.

Optionally, obtaining the light color information corresponding to the pixels in the target region in the mixed image based on the fifth image and the sixth image includes: determining initial light colors corresponding to the pixels in the target region in the mixed image based on the fifth image and the sixth image; determining a lighting correction amount based on a pixel variation amount corresponding to a target region in the sixth image, and correcting the initial light colors by using the lighting correction amount to obtain target light colors; and obtaining the light color information corresponding to the pixels in the target region in the mixed image according to the target light colors, the light intensities of pixels of the fifth image, and the sixth image.

An embodiment of the present disclosure further provides an image processing apparatus. The apparatus includes: an image obtaining module configured to obtain a first image and a second image; where the second image is an image obtained based on a material to be projected onto the first image; an image mixing module configured to: determine distortion information corresponding to pixels in the second image based on the first image, and generate a mixed image based on the first image, the second image, and the distortion information; an edge obtaining module configured to obtain target edge information of the mixed image; and an image generation module configured to generate a target image based on the mixed image and the target edge information.

An embodiment of the present disclosure further provides an electronic device. The electronic device includes: a processor; a memory configured to store instructions executable by the processor, where the processor is configured to: read the executable instructions from the memory, and execute the instructions to implement the image processing method according to the embodiments of the present disclosure.

An embodiment of the present disclosure further provides a computer-readable storage medium having a computer program stored therein. The computer program is configured to perform the image processing method according to the embodiments of the present disclosure.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a schematic flowchart of an image processing method according to an embodiment of the present disclosure;

FIG. 2 is a schematic diagram of determining a target region according to an embodiment of the present disclosure;

FIG. 3 is a schematic diagram of a foreground mask image according to an embodiment of the present disclosure;

FIG. 4 is a schematic diagram of a second image according to an embodiment of the present disclosure;

FIG. 5 is a schematic diagram of a third image according to an embodiment of the present disclosure;

FIG. 6 is a schematic diagram of a fourth image according to an embodiment of the present disclosure;

FIG. 7 is a schematic diagram of a fifth image according to an embodiment of the present disclosure;

FIG. 8 is a schematic diagram of a sixth image according to an embodiment of the present disclosure;

FIG. 9 is a schematic diagram of an image processing flow according to an embodiment of the present disclosure;

FIG. 10 is a schematic diagram of an image processing effect according to an embodiment of the present disclosure;

FIG. 11 is a schematic diagram of image drawing according to an embodiment of the present disclosure;

FIG. 12 is a schematic diagram of a structure of an image processing apparatus according to an embodiment of the present disclosure; and

FIG. 13 is a schematic diagram of a structure of an electronic device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

The inventor has found through research that existing types of effects for images are limited, making it difficult to meet diverse requirements of users. Therefore, new effects for images are urgently needed.

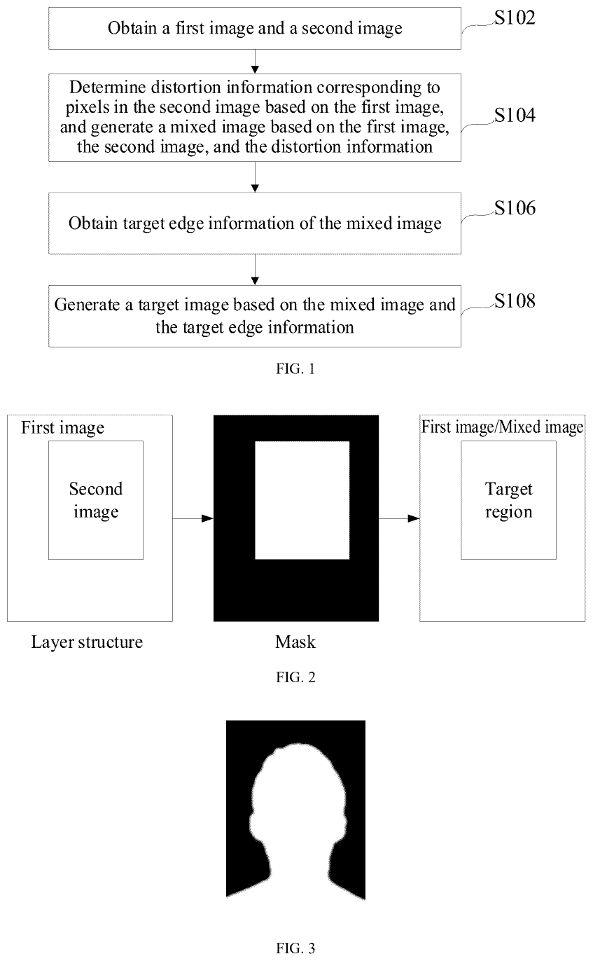

FIG. 1 is a schematic flowchart of an image processing method according to an embodiment of the present disclosure. The method may be performed by an image processing apparatus, which may be implemented using software and/or hardware and may generally be integrated into an electronic device. As shown in FIG. 1, the method mainly includes the following step S102 to step S108.

At step S102, a first image and a second image are obtained, where the second image is an image obtained based on a material to be projected onto the first image.

In practical applications, the first image may be referred to as an underlying image, and the second image may be referred to as an image to be projected or a material image. Content in the second image is material content to be projected onto the first image. The material to be projected onto the first image may be graphics, texts, images, or the like. If the material is an image, the image may be directly used as the second image. If the material is graphics or texts, for ease of processing, an image containing only the graphics or the texts may be generated as the second image. For ease of processing, pixel values of regions in the second image other than the material content can also be uniformly set to special values. For example, if a text is desired to be projected onto the first image, and the second image contains only an image of the text, the pixel values of the regions in the second image other than the text can be uniformly set to 0.

At step S104, distortion information corresponding to pixels in the second image is determined based on the first image, and a mixed image is generated based on the first image, the second image, and the distortion information.

The distortion information may also be referred to as deformation information. The distortion information may be specifically represented by a distortion coefficient, and may be used for determining position offset information of the pixels. Coordinate positions of the pixels are adjusted based on the position offset information, such that the material in the second image has a distortion effect or a deformation effect. In practical applications, since the second image is projected onto the first image, a distortion degree or a distortion manner of the pixels in the second image depends on the first image. Based on this, in this embodiment of the present disclosure, the distortion information corresponding to the pixels in the second image is determined based on the first image. For example, a distortion degree of the material is determined based on depth information and/or color information in the first image. If the second image is a text image, and the first image is a human face image, when different texts are projected onto different positions of a human face, distortion degrees presented are also different. For example, a distortion degree of texts projected onto the nose bridge may be greater than a distortion degree of texts projected onto the forehead.

In practical applications, the second image may be distorted based on distortion information, and then the first image may be overlaid with the distorted second image to obtain the mixed image.

At step S106, target edge information of the mixed image is obtained. Further, considering that an edge also has a crucial impact on a projection effect, this embodiment of the present disclosure may further obtain the target edge information of the mixed image. The target edge information may be information of all the edge lines in the mixed image, or may be information of some of the edge lines that satisfy a condition in the mixed image, such as information of edge lines in a target region to be processed in the mixed image.

At step S108, a target image is generated based on the mixed image and the target edge information.

In practical applications, processing can be performed based on the target edge information and the mixed image, so that the target image can present a more realistic projection effect based on a target edge. For example, a light color of the mixed image can be adjusted based on the target edge information, thus creating a feeling that the edge emits light and presenting a realistic projection effect.

The target image obtained by the above method can show a user a realistic protection effect, which is conductive to meeting a need of the user for effects.

Considering that a size of the second image may be different from a size of the first image, in order to improve the image processing efficiency and reduce a quantity of resources needing to be occupied by image processing, the above method further includes the following steps. A target region to be processed in the first image is determined based on layer information of the first image and layer information of the second image, where the layer information includes a layer size and a layer position. Based on this, distortion information corresponding to pixels in the second image is determined based on the first image, which includes: determining the distortion information corresponding to the pixels in the second image based on a target region in the first image; and target edge information of the mixed image is obtained, which includes: obtaining edge information of a target region in the mixed image to obtain the target edge information, where the target region in the mixed image corresponds to the target region in the first image. For ease of understanding, a further explanation is provided below.

In practical applications, if the layer size of the first image is consistent with the layer size of the second image, namely, the size of the first image is consistent with the size of the second image, the target region in the first image is the entire first image, which includes all pixels in the first image. If the layer size of the first image is inconsistent with the layer size of the second image, and the size of the second image is smaller than the size of the first image, the target region to be processed in the first image can be determined based on the layer size and position of the second image. The target region is a region obtained by projecting (i.e., performing texture overlay on) the second image onto the first image, and subsequent processing is mainly performed based on the target region. A non-target region in the first image is not affected by the second image and can just retain an original texture without processing. This method can avoid unnecessary computation, save computing power, and effectively improve the processing efficiency. For example, reference may be made to FIG. 2, which is a schematic diagram of determining a target region. First, a layer structure corresponding to a case where the first image and the second image have different sizes is shown. The layer sizes and positions of both the first image and the second image are shown. The layer of the second image is located on top of the layer of the first image. It can be understood that if the effect of projecting the material content of the second image onto the first image needs to be achieved, in order to improve the processing efficiency, the region of the second image that covers the first image is mainly processed. Specifically, a mask for identifying the target region can be obtained based on the layer structure of the first image and the second image. The mask may also be referred to as a mask of a material layer region, so that the target region to be processed in the first image or in the mixed image can be accurately and reliably positioned based on the mask subsequently. In other words, the target region to be processed in the first image and the target region to be processed in the mixed image are determined based on an overlay position of the layer of the second image on the layer of the first image.

In some implementations, the step that the distortion information corresponding to the pixels in the second image is determined based on the target region in the first image can be performed by the following step (1) to step (2).

At step (1), depth information of a first sub-region in the target region in the first image is obtained, and the distortion information of the pixels, corresponding to a position of the first sub-region, in the second image is determined based on the depth information. The first sub-region is a region, which has a specified object feature, in the target region. For example, the specified object feature can be a specified part feature of a target object. The specified part can be a non-planar part of the target object. For example, the specified part feature can be a facial feature of the target object such as a person and an animal. It can be understood that if the material is projected onto a rough object, distortion and other phenomena usually occur. Therefore, for the first sub-region with the specified object feature, this embodiment of the present disclosure can appropriately determine a distortion coefficient of the pixels corresponding to the position of the first sub-region in the second image based on the depth information of the region, and simulate, by using the distortion coefficient, a depth change of a specified part such as a face contour to distort the material, so that the distorted material in the second image can better fit the specified part such as the face contour.

At step (2), color information of a second sub-region in the target region in the first image is obtained, and the distortion information of the pixels, corresponding to a position of the second sub-region, in the second image is determined based on the color information. The second sub-region is a region in the target region other than the first sub-region. For a region without a specified object feature, such as a non-face region with a little depth change, a corresponding distortion coefficient can be calculated more quickly and more conveniently according to an RGB color value in the region.

Through the above method, different strategies can be used for different regions to distort an upper-layer material, which comprehensively ensures the distortion processing efficiency and the realistic distortion effect.

In some implementations, the step that edge information of the target region in the mixed image is obtained to obtain the target edge information can be performed by the following step 1 to step 2.

At step 1, edge extraction is performed on the target region in the mixed image to obtain an edge extraction result. This embodiment of the present disclosure does not limit an edge extraction method. For example, based on a phenomenon that pixels of an edge in an image change dramatically, an edge in the target region is extracted by calculating a color change rate, and the edge extraction result is obtained.

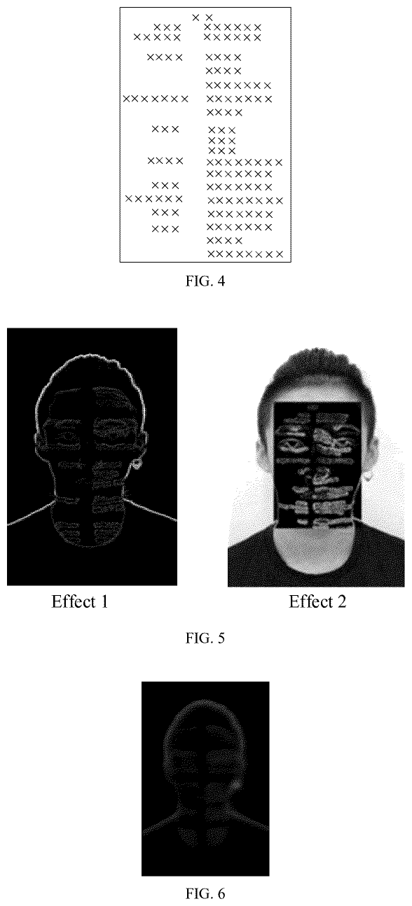

At step 2, a foreground mask image of the first image is obtained, and a third image is generated based on the foreground mask image and the edge extraction result, where a target region in the third image has a target edge texture, a foreground sub-region in the target region in the third image is a darkened region, a background sub-region in the target region in the third image is a brightened region, and the target region in the third image corresponds to the target region in the first image. In practical applications, a foreground region of the first image can be extracted through a background segmentation algorithm, thus generating the foreground mask image. The first image being a half-length photo of a person is taken as an example. Referring to FIG. 3 showing a schematic diagram of a foreground mask image, based on the edge extraction result, in conjunction with a foreground mask texture, the foreground sub-region in the target region can be darkened, and the background sub-region can be brightened, thereby enhancing a contrast between a foreground and a background, to calculate the target edge texture accurately and reliably and display the target edge texture on the third image clearly. For ease of understanding, if the second image is a character material image, FIG. 4 is a schematic diagram of a second image. In FIG. 4, all characters are illustrated as X. If a text material on the second image is projected onto a half-length photo of a person, a schematic diagram of a generated third image can be shown in FIG. 5, showing two effects of the third image. The third image corresponding to an effect 1 is generated when the size of the first image is consistent with the size of the second image (i.e. the target region is the entire image), and the third image corresponding to an effect 2 is generated when the size of the first image is inconsistent with the size of the second image (i.e. the target region is a local region). Both the effect 1 and the effect 2 show an effect of the third image with the target edge texture. For the effect 2, only the target region needs to be processed, and a non-target region still has a texture of the original first image. It can be seen from FIG. 5 that with the above method for obtaining the target edge information, an edge texture of a main object in the first image and an edge texture of the text material in the second image can be well presented in the target region of the third image.

In some implementations, the step that a target image is generated based on the mixed image and the target edge information may be performed by the following step I and step II.

At step I, light color information corresponding to pixels in the target region in the mixed image is obtained based on the mixed image and the target edge information. Considering that a sense of light is shown in most real projections, especially edges may show people a clearer glow, that is, showing a diffused hazy effect after projection of illumination light, in order to achieve a realistic projected light effect, in this embodiment of the present disclosure, the corresponding light color information of the pixels in the target region in the mixed image may be determined based on the mixed image and target edge information. A light color may be an overall color presented after one or more colors are overlaid together, such as an atmosphere light color (or an ambient light color), a highlight color, and specular light.

At step II, the target image is generated based on the light color information and the mixed image. Overlaying may be performed on the light color information and the mixed image to obtain the target image, thus creating a texture of a movie projection.

In some specific implementation examples, the target edge information is represented through the third image, and the target region in the third image has a target edge texture. The foregoing step I, namely, light color information corresponding to pixels in the target region in the mixed image is obtained based on the mixed image and the target edge information, can be performed by the following step A to step C.

At step A, Gaussian blurring is performed on the target region in the third image to obtain a fourth image. The Gaussian blurring can effectively simulate an effect of light scattering, that is, simulate a hazy and blurry feeling during light diffusion, thereby enhancing the realism of a subsequently obtained projection effect. For ease of understanding, based on the third image corresponding to Effect 1 in FIG. 5, the Gaussian blurring is performed on the third image, so that a schematic diagram of a fourth image as shown in FIG. 6 can be obtained.

At step B, a fifth image carrying light intensities of the pixels is generated based on the mixed image and the fourth image. In some specific implementation examples, step B can be performed by the following step B1 to step B2.

At step B1, the mixed image is fused with the fourth image to obtain the fifth image. That is, a basic mixed texture and a Gaussian texture are further mixed to enhance edge brightness.

At step B2, light intensities of pixels of a target region in the fifth image are determined based on grayscale values of the pixels of the target region in the mixed image, and the light intensities of the pixels are stored to a transparency channel of the fifth image. By calculating the light intensities of the pixels and directly storing the light intensities to the transparency channel, a light reference texture can be obtained for subsequent applications. The fifth image carrying the light intensities of the pixels may also be referred to as a light reference texture image. For ease of understanding, reference can be made to a schematic diagram of a fifth image as shown in FIG. 7. The transparency channel of the fifth image stores the light intensities of the pixels. FIG. 7 shows the fifth image obtained in a scenario where the size of the first image is consistent with the size of the second image. The target region of the fifth image is the entire region of the fifth image, including all pixels of the fifth image.

At step C, the light color information corresponding to the pixels in the target region in the mixed image is obtained based on the fifth image. In some specific implementation examples, step C can be performed by the following step C1 to step C2.

At step C1, Gaussian blurring is performed on a target region in the fifth image to obtain a sixth image. In order to enhance the simulation of the effect of light scattering and improve the realism of projection, the Gaussian blurring can be further performed on the target region in the fifth image. For example, the Gaussian blurring is performed based on the fifth image shown in FIG. 7 to obtain a schematic diagram of a sixth image shown in FIG. 8.

At step C2, the light color information corresponding to the pixels in the target region in the mixed image is obtained based on the fifth image and the sixth image. In some specific implementation examples, step C2 can be performed by the following step C2.1 to step C2.3.

At step C2.1, initial light colors corresponding to the pixels in the target region in the mixed image is determined based on the fifth image and the sixth image. In specific implementation, a light color can be calculated based on an externally preset glow intensity, the fifth image (i.e., the light reference texture), and the sixth image (i.e., a texture after Gaussian blurring), and the light color is the initial light color mentioned above.

At step C2.2, a lighting correction amount is determined based on a pixel variation amount corresponding to a target region in the sixth image, and the initial light colors are corrected by using the lighting correction amount to obtain target light colors. The pixel variation amount corresponding to the target region in the sixth image is a pixel variation amount of the target region in the fifth image after Gaussian blurring. The pixel variation amount can be used as the lighting correction amount. Then, the lighting correction amount is used to update the initial light color, so that a pixel that becomes brighter due to the Gaussian blurring is corrected to a darker value, and a pixel that becomes darker due to the Gaussian blurring is corrected to a brighter value, thereby ensuring the accuracy of the finally obtained target light color.

At step C2.3, the light color information corresponding to the pixels in the target region in the mixed image is obtained according to the target light color, light intensities of pixels of the fifth image, and the sixth image.

Specifically, the target light color and the sixth image (i.e. the light reference texture after Gaussian blurring) can be mixed, and are overlaid with the light intensities of the pixels that are stored in the transparency channel of the fifth image, to obtain the final color, namely, to obtain the light color information corresponding to the pixels in the target region in the mixed image. Finally, the light color is overlaid onto the mixed image, and the target image with a realistic projection feeling can be obtained.

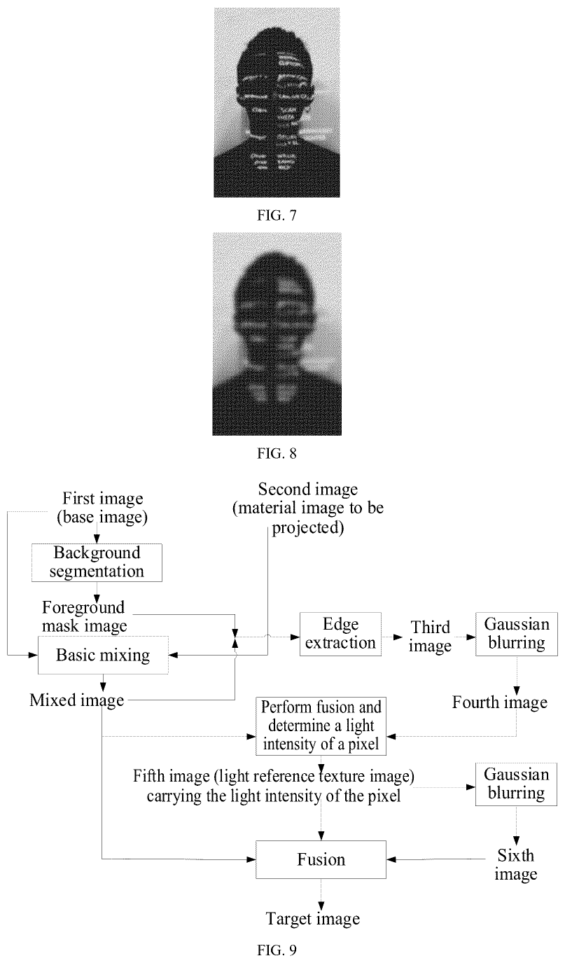

For ease of understanding, reference may be made to FIG. 9, which is a schematic diagram of an image processing flow, and shows a specific flow of generating a target image based on a first image (a base image) and a second image (a material image to be projected). A foreground mask image can be obtained from the first image through background segmentation. Basic mixing is performed on the first image and the second image to obtain a mixed image. Then, edge extraction or another operation is performed on the foreground mask image and the mixed image to obtain a third image having an edge texture. Gaussian blurring is performed on the third image to obtain a fourth image. The mixed image and the fourth image are fused, and light intensities of pixels are determined, thus obtaining a fifth image (light reference texture image) carrying the light intensities of the pixels. Gaussian blurring is further performed on the fifth image to obtain a sixth image. Finally, fusion is performed based on the mixed image, the fifth image, and the sixth image, such that a target image with a realistic projection effect can be obtained. It should be noted that the target image in FIG. 9 is an image that is finally expected to be obtained and displayed, and the foreground mask image, the mixed image, and the third image to the sixth image are all intermediate data required in the generation flow of the target image. The specific implementations and functions of the above steps can be found in the relevant content mentioned above, and will not be described herein again.

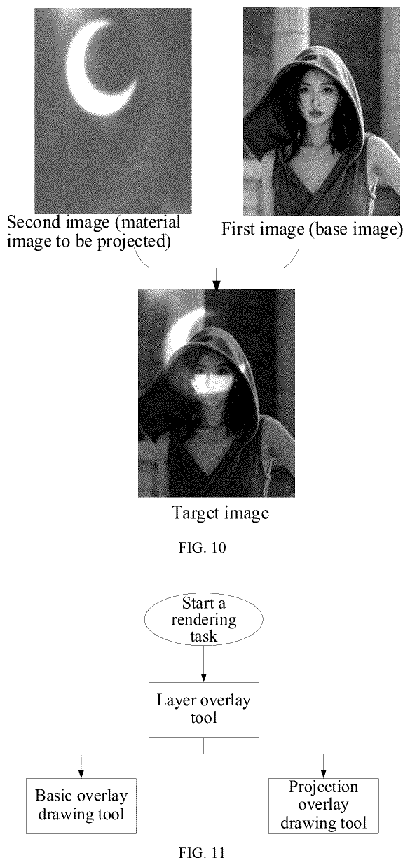

For convenience of understanding of the effect of the image processing method provided in this embodiment of the present disclosure, reference may be made to FIG. 10, which is a schematic diagram of an image processing effect that can present a user with a realistic projection effect.

In practical applications, the above image processing method provided in this embodiment of the present disclosure can be applied to a layer overlay scenario. For example, in an image editing scenario containing a plurality of layers, a respective layer overlay mode can be defined for each layer. The layer overlay mode may include a basic overlay mode and a projection overlay mode, which may be specifically selected by a user as needed. For example, the basic overlay mode may be used for a portrait base image and a landscape material image, and the projection overlay mode may be used for a portrait base image and a text material image. In the basic overlay mode, a simple color mixing logic is executed. In the projection overlay mode, the image processing logic provided in the embodiments of the present disclosure is executed. In practical applications, reference may be made to FIG. 11, which is a schematic diagram of image drawing. After a rendering task is started, a drawing task may be assigned through a layer overlaying tool. A basic overlay drawing tool or a projection overlay drawing tool can be selected for image drawing according to an overlay mode corresponding to a layer, thereby displaying an image desired by a user. According to the overlay modes of layers, the layer overlay tool may merge final results output from these layers. A result of each overlay may be used as a base image for next mixing. Through the above method, convenient layer overlay management can be achieved on the basis of introduction of the projection overlay mode into the embodiments of the present disclosure.

In summary, the image processing method according to this embodiment of the present disclosure can be applied into image overlay management as a new projection overlay mode, to provide a user with a realistic projection effect.

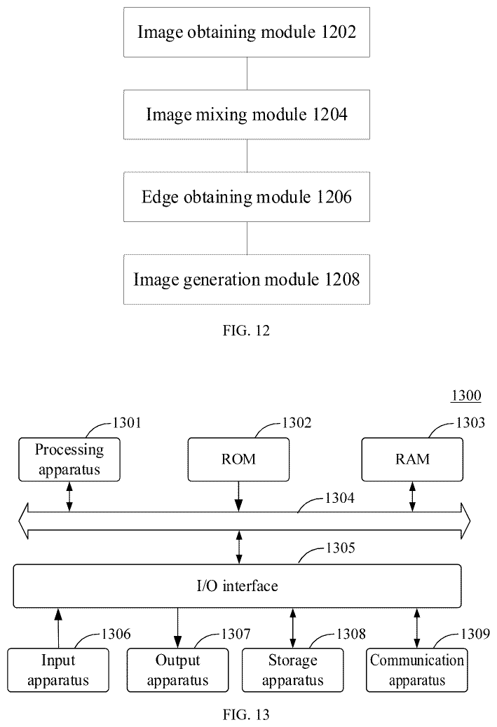

Corresponding to the foregoing image processing method, an embodiment of the present disclosure further provides an image processing apparatus. FIG. 12 is a schematic structural diagram of an image processing apparatus according to an embodiment of the present disclosure. The apparatus may be implemented using software and/or hardware and may be usually integrated in an electronic device. As shown in FIG. 12, the image processing apparatus includes:
an image obtaining module 1202 configured to obtain a first image and a second image, where the second image is an image obtained based on a material to be projected onto the first image;
an image mixing module 1204 configured to: determine distortion information corresponding to pixels in the second image based on the first image, and generate a mixed image based on the first image, the second image, and the distortion information;
an edge obtaining module 1206 configured to obtain target edge information of the mixed image; and
an image generation module 1208 configured to generate a target image based on the mixed image and the target edge information.

The above apparatus according to the embodiments of the present disclosure fully considers that most real projections may be distorted, so that the distortion information corresponding to the pixels in the second image to be projected is determined based on the first image; and then, the mixed image is generated based on the first image, the second image, and the distortion information. Furthermore, considering that an edge also has a crucial impact on a projection effect, the target image may be further generated based on the mixed image and the target edge information of the mixed image. The target image obtained by the above method can achieve a realistic effect of projecting the material onto the first image, namely, can provide a user with a realistic projection effect, which is conductive to meeting a need of the user for effects.

In some implementations, the apparatus further includes a region determining module configured to determine a target region to be processed in the first image based on layer information of the first image and layer information of the second image, where the layer information includes a layer size and a layer position. The image mixing module 1204 is specifically configured to: determine the distortion information corresponding to the pixels in the second image based on a target region in the first image. The edge obtaining module 1206 is specifically configured to: obtain edge information of a target region in the mixed image to obtain the target edge information, where the target region in the mixed image corresponds to the target region in the first image.

In some possible implementations, the image mixing module 1204 is specifically configured to: obtain depth information of a first sub-region in the target region in the first image, and determine the distortion information of the pixels, corresponding to a position of the first sub-region, in the second image based on the depth information, where the first sub-region is a region, having a specified object feature, in the target region; and obtain color information of a second sub-region in the target region in the first image, and determine the distortion information of the pixels, corresponding to a position of the second sub-region, in the second image based on the color information, where the second sub-region is a region in the target region other than the first sub-region.

In some implementations, the edge obtaining module 1206 is specifically configured to: perform edge extraction on the target region in the mixed image to obtain an edge extraction result; and obtain a foreground mask image of the first image, and generate a third image based on the foreground mask image and the edge extraction result, where a target region in the third image has a target edge texture, a foreground sub-region in the target region in the third image is a darkened region, a background sub-region in the target region in the third image is a brightened region, and the target region in the third image corresponds to the target region in the first image.

In some implementations, the image generation module 1208 is specifically configured to: obtain light color information corresponding to pixels in the target region in the mixed image based on the mixed image and the target edge information; and generate the target image based on the light color information and the mixed image.

In some implementations, the target edge information is represented through the third image, and the target region in the third image has a target edge texture. The image generation module 1208 is specifically configured to: perform Gaussian blurring on the target region in the third image to obtain a fourth image; generate, based on the mixed image and the fourth image, a fifth image carrying light intensities of the pixels; and obtain the light color information corresponding to the pixels in the target region in the mixed image based on the fifth image.

In some implementations, the image generation module 1208 is specifically configured to: fuse the mixed image with the fourth image to obtain the fifth image; and determine light intensities of pixels of a target region in the fifth image based on grayscale values of the pixels of the target region in the mixed image, and store the light intensities of the pixels to a transparency channel of the fifth image.

In some implementations, the image generation module 1208 is specifically configured to: perform Gaussian blurring on a target region in the fifth image to obtain a sixth image; and obtain the light color information corresponding to the pixels in the target region in the mixed image based on the fifth image and the sixth image.

In some implementations, the image generation module 1208 is specifically configured to: determine initial light colors corresponding to the pixels in the target region in the mixed image based on the fifth image and the sixth image; determine a lighting correction amount based on a pixel variation amount corresponding to a target region in the sixth image, and correcting the initial light colors by using the lighting correction amount to obtain target light colors; and obtain the light color information corresponding to the pixels in the target region in the mixed image according to the target light colors, light intensities of pixels of the fifth image, and the sixth image.

The image processing apparatus according to this embodiment of the present disclosure can perform the image processing method according to any embodiment of the present disclosure, and has corresponding functional modules and beneficial effects for performing the method.

It can be clearly understood by those skilled in the art that, for convenience and brevity of description, for the specific operation processes of the apparatus embodiment described above, reference may be made to the corresponding processes in the foregoing method embodiments, and details are not described herein again.

An embodiment of the present disclosure provides an electronic device. The electronic device includes: a storage apparatus having a computer program stored thereon; and a processing apparatus configured to execute the computer program in the storage apparatus to achieve the steps of any method in the present disclosure.

Reference is now made to FIG. 13 below, which illustrates a schematic structural diagram of an electronic device 1300 suitable for implementing the embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 13 is only an example and should not impose any limitations on the functionality and scope of use of the embodiments of the present application.

As shown in FIG. 13, the electronic device 1300 may include a processing apparatus (e.g., a central processing unit and graphics processor) 1301 that can perform various appropriate actions and processing according to programs stored in a read-only memory (ROM) 1302 or loaded from a storage apparatus 1308 to a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touchscreen, a touchpad, a keyboard, a mouse, a camera, a microphone, an accelerometer, and a gyroscope; an output apparatus 1307 including, for example, a liquid crystal display (LCD), a speaker, and a vibrator; the storage apparatus 1308 including, for example, a tape and a hard disk; and a communication apparatus 1309. The communication apparatus 1309 can allow the electronic device 1300 to perform wireless or wired communication with other devices to exchange data. Although FIG. 13 shows the electronic device 1300 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 1309, or installed from the memory 1308, or installed from the ROM 1302. When the computer program is executed by the processing apparatus 1301, the above-mentioned functions defined in the methods of the embodiments of the present application are executed.

In addition to the above method and device, an embodiment of the present disclosure may further be a computer program product, including computer program instructions that, when executed by a processor, cause the processor to perform the image processing method according to the embodiments of the present disclosure. In the computer program product, program codes for performing the operations of the embodiments of the present disclosure may be written in any combination of one or more programming languages, where the programming languages include an object oriented programming language, such as Java, and C++, and further include conventional procedural programming languages, such as “C” language or similar programming languages. The program codes may be completely executed on a user computing device, partially executed on a user device, executed as an independent software package, executed partially on a user computing device and partially on a remote computing device, or completely executed on a remote computing device or a server.

In addition, an embodiment of the present disclosure may further be a computer-readable storage medium, having computer program instructions stored therein. The computer program instructions, when executed by a processor, cause the processor to perform the image processing method according to the embodiments of the present disclosure.

The computer-readable storage medium may be any combination of one or more readable media. The readable medium may be a readable signal medium or a readable storage medium. The readable storage medium may include, for example, but not limited to, an electronic, magnetic, optical, electromagnetic, infrared, or semiconductor system, apparatus, or device, or any combination thereof. More specific examples of the readable storage media (a non-exhaustive list) include: an electrical connection having one or more wires, a portable disk, a hard disk, a random access memory (RAM), a read-only memory (ROM), an erasable programmable read-only memory (EPROM or flash), an optic fiber, a portable compact disk read-only memory (CD-ROM), an optical storage device, a magnetic storage device, or any suitable combination thereof.

An embodiment of the present disclosure further provides a computer program product, including a computer program/instruction that, when executed by a processor, implements the image processing method according to the embodiments of the present disclosure.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It should be noted that the relational terms such as “first” and “second” herein are only used to distinguish one entity or operation from another, and do not necessarily require or imply that any actual relationship or sequence exists between these entities or operations. Moreover, the terms “include” and “include”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The above description illustrates merely specific implementations of the present disclosure, so that a person skilled in the art can understand or implement the present disclosure. Various modifications to these embodiments are apparent to a person skilled in the art, and the general principle defined herein may be practiced in other embodiments without departing from the spirit or scope of the present disclosure. Therefore, the present disclosure is not limited to the embodiments described herein but is to be accorded the broadest scope consistent with the principle and novel features disclosed herein.

I/We claim:

1. An image processing method, comprising:
obtaining a first image and a second image, wherein the second image is an image obtained based on a material to be projected onto the first image;
determining distortion information corresponding to pixels in the second image based on the first image, and generating a mixed image based on the first image, the second image, and the distortion information;
obtaining target edge information of the mixed image; and
generating a target image based on the mixed image and the target edge information.

2. The method according to claim 1, further comprising: determining a target region to be processed in the first image based on layer information of the first image and layer information of the second image, wherein the layer information comprises a layer size and a layer position;
wherein determining the distortion information corresponding to pixels in the second image based on the first image comprises: determining the distortion information corresponding to the pixels in the second image based on the target region in the first image; and
wherein obtaining the target edge information of the mixed image comprises: obtaining edge information of a target region in the mixed image to obtain the target edge information, wherein the target region in the mixed image corresponds to the target region in the first image.

3. The method according to claim 2, wherein determining the distortion information corresponding to the pixels in the second image based on the target region in the first image comprises:
obtaining depth information of a first sub-region in the target region in the first image, and determining distortion information of pixels, corresponding to a position of the first sub-region, in the second image based on the depth information, wherein the first sub-region is a region, having a specified object feature, in the target region; and
obtaining color information of a second sub-region in the target region in the first image, and determining distortion information of pixels, corresponding to a position of the second sub-region, in the second image based on the color information, wherein the second sub-region is a region in the target region other than the first sub-region.

4. The method according to claim 2, wherein obtaining the edge information of the target region in the mixed image to obtain the target edge information comprises:
performing edge extraction on the target region in the mixed image to obtain an edge extraction result; and
obtaining a foreground mask image of the first image, and generating a third image based on the foreground mask image and the edge extraction result, wherein a target region in the third image has a target edge texture, a foreground sub-region in the target region in the third image is a darkened region, a background sub-region in the target region in the third image is a brightened region, and the target region in the third image corresponds to the target region in the first image.

5. The method according to claim 2, wherein generating the target image based on the mixed image and the target edge information comprises:
obtaining light color information corresponding to pixels in the target region in the mixed image based on the mixed image and the target edge information; and
generating the target image based on the light color information and the mixed image.

6. The method according to claim 4, wherein the target edge information is represented through the third image, and the target region in the third image has the target edge texture; and wherein obtaining light color information corresponding to pixels in the target region in the mixed image based on the mixed image and the target edge information comprises:
performing Gaussian blurring on the target region in the third image to obtain a fourth image;
generating, based on the mixed image and the fourth image, a fifth image carrying light intensities of the pixels; and
obtaining the light color information corresponding to the pixels in the target region in the mixed image based on the fifth image.

7. The method according to claim 6, wherein generating, based on the mixed image and the fourth image, the fifth image carrying the light intensities of the pixels comprises:
fusing the mixed image with the fourth image to obtain the fifth image; and
determining the light intensities of pixels of a target region in the fifth image based on grayscale values of the pixels of the target region in the mixed image, and storing the light intensities of the pixels to a transparency channel of the fifth image.

8. The method according to claim 6, wherein obtaining the light color information corresponding to the pixels in the target region in the mixed image based on the fifth image comprises:
performing Gaussian blurring on a target region in the fifth image to obtain a sixth image; and
obtaining the light color information corresponding to the pixels in the target region in the mixed image based on the fifth image and the sixth image.

9. The method according to claim 8, wherein obtaining the light color information corresponding to the pixels in the target region in the mixed image based on the fifth image and the sixth image comprises:
determining initial light colors corresponding to the pixels in the target region in the mixed image based on the fifth image and the sixth image;
determining a lighting correction amount based on a pixel variation amount corresponding to a target region in the sixth image, and correcting the initial light colors by using the lighting correction amount to obtain target light colors; and
obtaining the light color information corresponding to the pixels in the target region in the mixed image according to the target light colors, the light intensities of pixels of the fifth image, and the sixth image.

10. An electronic device, comprising:
a storage apparatus having a computer program stored thereon; and
a processing apparatus configured to execute the computer program in the storage apparatus to cause the electronic device to:
obtain a first image and a second image, wherein the second image is an image obtained based on a material to be projected onto the first image;
determine distortion information corresponding to pixels in the second image based on the first image, and generate a mixed image based on the first image, the second image, and the distortion information;
obtain target edge information of the mixed image; and
generate a target image based on the mixed image and the target edge information.

11. The electronic device according to claim 10, wherein the computer program, when executed, further causes the electronic device to: determine a target region to be processed in the first image based on layer information of the first image and layer information of the second image, wherein the layer information comprises a layer size and a layer position;
wherein the computer program causing the electronic device to determine the distortion information corresponding to pixels in the second image based on the first image causes the electronic device to: determine the distortion information corresponding to the pixels in the second image based on the target region in the first image; and
wherein the computer program causing the electronic device to obtain the target edge information of the mixed image causes the electronic device to: obtain edge information of a target region in the mixed image to obtain the target edge information, wherein the target region in the mixed image corresponds to the target region in the first image.

12. The electronic device according to claim 11, wherein the computer program causing the electronic device to determine the distortion information corresponding to the pixels in the second image based on the target region in the first image causes the electronic device to:
obtain depth information of a first sub-region in the target region in the first image, and determine distortion information of pixels, corresponding to a position of the first sub-region, in the second image based on the depth information, wherein the first sub-region is a region, having a specified object feature, in the target region; and
obtain color information of a second sub-region in the target region in the first image, and determine distortion information of pixels, corresponding to a position of the second sub-region, in the second image based on the color information, wherein the second sub-region is a region in the target region other than the first sub-region.

13. The electronic device according to claim 11, wherein the computer program causing the electronic device to obtain the edge information of the target region in the mixed image to obtain the target edge information causes the electronic device to:
perform edge extraction on the target region in the mixed image to obtain an edge extraction result; and
obtain a foreground mask image of the first image, and generate a third image based on the foreground mask image and the edge extraction result, wherein a target region in the third image has a target edge texture, a foreground sub-region in the target region in the third image is a darkened region, a background sub-region in the target region in the third image is a brightened region, and the target region in the third image corresponds to the target region in the first image.

14. The electronic device according to claim 11, wherein the computer program causing the electronic device to generate the target image based on the mixed image and the target edge information causes the electronic device to:
obtain light color information corresponding to pixels in the target region in the mixed image based on the mixed image and the target edge information; and
generate the target image based on the light color information and the mixed image.

15. The electronic device according to claim 13, wherein the target edge information is represented through the third image, and the target region in the third image has the target edge texture; and wherein the computer program causing the electronic device to obtain light color information corresponding to pixels in the target region in the mixed image based on the mixed image and the target edge information causes the electronic device to:
perform Gaussian blurring on the target region in the third image to obtain a fourth image;
generate, based on the mixed image and the fourth image, a fifth image carrying light intensities of the pixels; and
obtain the light color information corresponding to the pixels in the target region in the mixed image based on the fifth image.

16. The electronic device according to claim 15, wherein the computer program causing the electronic device to generate, based on the mixed image and the fourth image, the fifth image carrying the light intensities of the pixels causes the electronic device to:
fuse the mixed image with the fourth image to obtain the fifth image; and
determine the light intensities of pixels of a target region in the fifth image based on grayscale values of the pixels of the target region in the mixed image, and store the light intensities of the pixels to a transparency channel of the fifth image.

17. The electronic device according to claim 15, wherein the computer program causing the electronic device to obtain the light color information corresponding to the pixels in the target region in the mixed image based on the fifth image causes the electronic device to:
perform Gaussian blurring on a target region in the fifth image to obtain a sixth image; and
obtain the light color information corresponding to the pixels in the target region in the mixed image based on the fifth image and the sixth image.

18. The electronic device according to claim 17, wherein the computer program causing the electronic device to obtain the light color information corresponding to the pixels in the target region in the mixed image based on the fifth image and the sixth image causes the electronic device to:
determine initial light colors corresponding to the pixels in the target region in the mixed image based on the fifth image and the sixth image;
determine a lighting correction amount based on a pixel variation amount corresponding to a target region in the sixth image, and correct the initial light colors by using the lighting correction amount to obtain target light colors; and
obtain the light color information corresponding to the pixels in the target region in the mixed image according to the target light colors, the light intensities of pixels of the fifth image, and the sixth image.

19. A non-transitory computer-readable storage medium, having a computer program stored therein, wherein the computer program is used to:
obtain a first image and a second image, wherein the second image is an image obtained based on a material to be projected onto the first image;
determine distortion information corresponding to pixels in the second image based on the first image, and generate a mixed image based on the first image, the second image, and the distortion information;
obtain target edge information of the mixed image; and
generate a target image based on the mixed image and the target edge information.

20. The non-transitory computer-readable storage medium according to claim 19, wherein the computer program is further used to: determine a target region to be processed in the first image based on layer information of the first image and layer information of the second image, wherein the layer information comprises a layer size and a layer position;
wherein the computer program being used to determine the distortion information corresponding to pixels in the second image based on the first image is used to: determine the distortion information corresponding to the pixels in the second image based on the target region in the first image; and
wherein the computer program being used to obtain the target edge information of the mixed image is used to: obtain edge information of a target region in the mixed image to obtain the target edge information, wherein the target region in the mixed image corresponds to the target region in the first image.
